(19) United States
(12) Patent Application Publication
(10) Pub. No.: US 2016/0247353 A1
(43) Pub. Date: Aug. 25, 2016

(54) GAMING GAMBLING MACHINES

(71) Applicant: Thomas A. Pallow, North Tustin, CA (US)

(72) Inventor: Thomas A. Pallow, North Tustin, CA (US)

(21) Appl. No.: 15/052,629

(22) Filed: Feb. 24, 2016

Related U.S. Application Data
(60) Provisional application No. 62/120,170, filed on Feb. 24, 2015.

(51) Int. Cl. G07F 17/32

(52) U.S. Cl. CPC G07F 17/3244

(57) ABSTRACT

A gaming gambling machine is disclosed that alters the payout rate of a player based upon the performance of the player with respect to the performance of other players. Because multiple players could be playing games within the same time period, the payout rates of the players can vary above and below 100% while the casino continues to operate at a profit since the system ensures that the average payout rate of all players lies at an average predictable rate below 100%.

This application claims the benefit of priority to U.S. provisional application 62/120,170 filed on Feb. 24, 2015. This and all other extrinsic references referenced herein are incorporated by reference in their entirety.

### FIELD OF THE INVENTION

The field of the invention is gambling machines

### BACKGROUND

The background description includes information that may be useful in understanding the present invention. It is not an admission that any of the information provided herein is prior art or relevant to the presently claimed invention, or that any publication specifically or implicitly referenced is prior art.

Billions of dollars are spent each year in various forms of gambling. To meet the population's gambling needs, a wide range of gambling technologies have emerged. The slot machine industry itself is roughly a $5 billion a year industry. That means that every year throughout the world, $5 billion is spent by casinos and others on brand new slot machines. This industry follows decades of relatively rapid growth throughout the world, especially is the U.S. and particularly due to the enormous increase in casinos throughout many Native American reservations, many of which that would otherwise be relatively poor. While the casino and slot machine industries have greatly expanded over the past 20 year in the United States as well as throughout the world, all forms of gambling on the Internet have begun to greatly cut into casino gaming profits both in the United States and abroad. Moreover, about 60% of casino gambling revenues are generated from their slot machines, and over the past few decades slot machine revenues have declined, and just at a time when the average age of a slot machine player is older than perhaps it has ever been and even may be dying out! Therefore, casinos must fine a way to bring a new and younger demographic into their properties to gamble.

Thus, there remains a need for a system and method that improves the state of the art of gambling machines.

### SUMMARY OF THE INVENTION

The following description includes information that may be useful in understanding the present invention. It is not an admission that any of the information provided herein is prior art or relevant to the presently claimed invention, or that any publication specifically or implicitly referenced is prior art.

The inventive subject matter provides apparatus, systems, and methods to adjust the winning odds of a gaming gambling machine (“GGM”) as a function of the performance of a player of a game.

In one embodiment, a GGM is a gambling machine that can exist in countless physical forms, but will often exist in a physical form that resembles a cross between a modern slot machine and a modern computer arcade game. In some embodiments, in the place of the spinning reels of a slot machine, the GGM includes virtually any type of computerized video game. For example, the GGM can be physically structured with small to very elaborate exteriors that enlarge and/or enhance the GGM experience. For example, a GGM video motorcycle racing game can have a full set of motorcycle handlebars for the player to use while playing and/or up to a full replica of a motorcycle to sit on while playing or the GGM video game can be controlled by a system as simple as an ordinary motorcycle hand and foot throttles and brakes, or a joystick or one or more buttons. As another example, a GGM climbing game may include a full scale, three story rock climbing wall. In some embodiments, the GGM includes video games that can be played for varying lengths of time periods and/or can include initial sessions that can be extended to additional sessions, for example, if the user pays for additional sessions.

In one embodiment, one of the primary features of GGMs is that the better players of the GGM play relative to other players of that GGM, the higher will be the probability of a monetary payout. In other words, the better scoring players from that GGM will have a higher probability of a monetary payout, and the worse the player plays relative to other players of that GGM the lower will be the probability of monetary payout. Moreover, in some embodiments, the numeric range of probability of payout between the best and worst players of a GGM, and all those in between, can be made as small and as large as desired. Another primary feature of some embodiments of GGMs is that GGMs can be designed such that the overall average probability of monetary payout for each GGM is on average like that of a typical modern slot machine. That average is commonly between around 94% to around 97%. What this means is that, even though GGMs can be adjusted such that the best players will likely have a chance of payout that is virtually unlimitedly larger than that of the worst players of that GGM and virtually unlimitedly higher above a 100% payout rate. A GGM can be configured to have a total monetary payout that averages, for example, 97 cents for every dollar that is spent playing that GGM. In some of these embodiments, the probably is always on average like that of a typical modern slot machine whereas in other of these embodiments, the probably is sometimes on average like that of a typical modern slot machine or different from a slot machine.

Some current technologies allow computer game players to compete with each other, typically over the Internet, with the top players winning monetary and other prizes through the distribution of a pool of money that is collected from each player before the game is started. This technology, however, has been shown to incentivize generally only the most skilled players to play because only the most skilled players can win, so this market ends up being relatively small. In order to compensate for only the most skilled gamers playing, other existing technology attempts to match competitors of games in pools of players with similar skill levels. The major problems with this second technology are that it can be cheated regarding skill level, but even more importantly, players typically must wait long periods of time, typically 20 minutes to an hour or more, before any prize or money payout can be made due to the systems method of matching players into pools of similar skill levels and then recognizing and awarding top players. However, in some embodiments, GGMs allow all players to have a chance of winning a payout, although the better players may virtually always have a higher probability of winning, and/or GGMs can make payouts instantaneously in real-time while being played and can make multiple payouts while being played.

However, the skill-based video gambling platform, GGM platform, in this patent allows for virtually an unlimited amount of instantaneous, or otherwise, payout opportunities in any single one game played, and these instantaneous, or otherwise, payout opportunities can have payout rates well above and below 100%. Moreover, the ranges of the payout rates, for the worst to best scoring payers and those in-between, can be varied with every instantaneous, or otherwise, payout opportunity, and also that that variability can be changed in either a predictable or unpredictable manner with each new single game played.

GGMs are a greatly needed, able, and willing boost into the demand and profit margins for America's and the world's casinos. GGMs will be an essential component in creating the finest Destination Gaming experiences in the world and a great improvement on the modern slot machine and any other skill-based video gambling machines, where, players can sit on motorcycles, buck on broncos, or simply turn a wheel, all while competing in their favorite video games where the better they score relative to others, the more likely they will win jackpots! In some embodiments, the software for each GGM can be compatible with all, or as many as chosen, of the GGM exterior components, so that brand new GGMs can be relatively cheaply created. Also, in some embodiments, there will be an incentive within the video gamer market to play and market the video games that are used within the GGMs, because by playing video games disclosed herein, or those very similar to them, one will improve their ability to more likely win money at some casino with one of the GGMs. This incentive will be used in a fair and equitable manner and lead by a great American industry. Since the 1800s America has always been the world's preeminent leader in gaming, this due to its libertarian and old west traditions that continue, its world class technologies, and its state policing of gaming that has traditionally been administered cleaner than any other gambling destinations on earth. GGMs can continue this tradition, creating great American jobs and enabling GGMs to be exported throughout the world, with the world's newest and most popular GGMs first in America's top casinos!

It is recognized that in some embodiments, GGMs can function as single game units where scores of players are ranked against scores of past players, or as connected systems of multiple GGMs, connected or not connected to the Internet or a network, where multiple scores are ranked in real-time or otherwise.

The terms “user,” “player,” “racer,” “motorcycle racer,” “gamer,” “gambler,” “individual,” “consumer,” “customer,” “people,” “persons,” “party,” “entity,” and the like, whether singular or plural, should be interpreted to include either individuals or groups of individuals that can access and utilize the GGMs. In addition, it is recognized that payment for the GGMs can be utilized by actual currency, an electronic account, an electronic payment instrument (such as, for example, a debit card, a credit card, a gift card, and so forth), as well as other payment methods.

Casino operators know that they have new and exciting gambling machines that have perfectly predictable overall payout rates just like their slot machines, for example 95%, 97%, or virtually any other percent desired, yet these machines will be much more engaging and popular to play, with any video game where player scores could be ranked or ordered in some manner by a computer module.

The generations that have grown up playing video games are now about age 50 and younger. Gaming Gambling Machines, or skill-based video gambling machines, create a much more exciting gambling and casino experience for these younger generations and all and both genders.

No other gambling machine allows for multiple payout opportunities throughout each game and payout rates above 100%. That is, with the GGM system and embodiment in this patent, gamblers/players can achieve multiple payout rates as high as, for example, 147%, or lower or even much higher. Therefore, for every one dollar of play that a gambler with this GGM plays well enough to achieve payout rates of 147%, they will, most likely, over the same time have a payout of $1.47. Virtually all slot machines and all other skill-based video gambling machines only have payout opportunities with payout rates below 100%, for example 95%. This means that, most likely, over time, for every dollar that is gambled with such a machine, 95 cents will be won be the gambler in payouts. In other words, with this patents GGM system, gamblers will always know that they will be more likely to beat the casino, or beat the house, if they score better than, for example in this embodiment, 43.2% of the past or current players of this same GGM or connected GGM. The payers of these GGMs will have the novel and unique, euphoric knowledge that they can beat the house with multiple payout opportunities, while all players of even the lowest skill will have a good chance at jackpots. These GGMs will bring in new and repeat gamblers into casinos more than will any other skill-based video game and perhaps anything else!

Various objects, features, aspects and advantages of the inventive subject matter will become more apparent from the following detailed description of preferred embodiments, along with the accompanying drawing figures in which like numerals represent like components.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

### BRIEF DESCRIPTION OF THE DRAWING

FIG. 1 is a block diagram illustrating one embodiment of a gaming gambling machine system.

FIG. 2 is a flow chart illustrating one embodiment in which gaming gambling machine system is in communication with a network and various systems, such as player databases and/or gaming institutions, are also in communication with the network.

FIG. 3 is a logical flow diagram for one embodiment of an example process for calculating payouts which may be run by one embodiment of the gaming gambling machine system.

### DETAILED DESCRIPTION

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

It should be noted that any language directed to a computer system should be read to include any suitable combination of computing devices, including servers, interfaces, systems, databases, agents, peers, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

Embodiments of the disclosure will now be described with reference to the accompanying figures. The terminology used in the description presented herein is not intended to be interpreted in any limited or restrictive manner, simply because it is being utilized in conjunction with a detailed description of certain specific embodiments of the disclosure. Furthermore, embodiments of the disclosure may include several novel features, no single one of which is solely responsible for its desirable attributes or which is essential to practicing the embodiments of the disclosure herein described. Moreover, for purposes of this disclosure, certain aspects, advantages, and novel features of various embodiments are described herein. It is to be understood that not necessarily all such advantages may be achieved in accordance with any particular embodiment of the invention. Thus, for example, those skilled in the art will recognize that one embodiment may be carried out in a manner that achieves one advantage or group of advantages as taught herein without necessarily achieving other advantages as may be taught or suggested herein.

One should appreciate that the disclosed techniques provide many advantageous technical effects including dynamically altering the payout rates of multiple players playing games, and enabling a casino to award over 100% payout rates to certain players while still maintaining a profit by averaging all payout rates among all players.

One should appreciate that the disclosed techniques provide significantly more than the application of an altered payout rate for a player calculated as a function of his/her score in a game. For example, the disclosed techniques add specific limitations other than what is well-understood, routine, and conventional by allowing a casino to provide a machine having a payout rate over 100% by averaging the payout rates of multiple networked machines played simultaneously. The disclosed techniques also add unconventional steps that confine the claim to the particular useful application of gaming gambling machines by adjusting the payout formula specifically to gambling machines as each player plays a game. The disclosed techniques also add meaningful limitations that amount more than generally linking the use of an altered payout rate for a player to a particular gambling machine by providing that the payout adjuster continuously alters the payout rates over time while the player progresses through a game. The disclosed techniques also applies the altered payout rate concept to particularly multi-player gambling games, which allows the casino to provide a payout rate above 100%.

The inventive subject matter provides apparatus, systems, and methods that allows a gambling system to provide payout rates over 100% while still guaranteeing that the casino makes money from gambling players.

Gaming Gambling Machine System

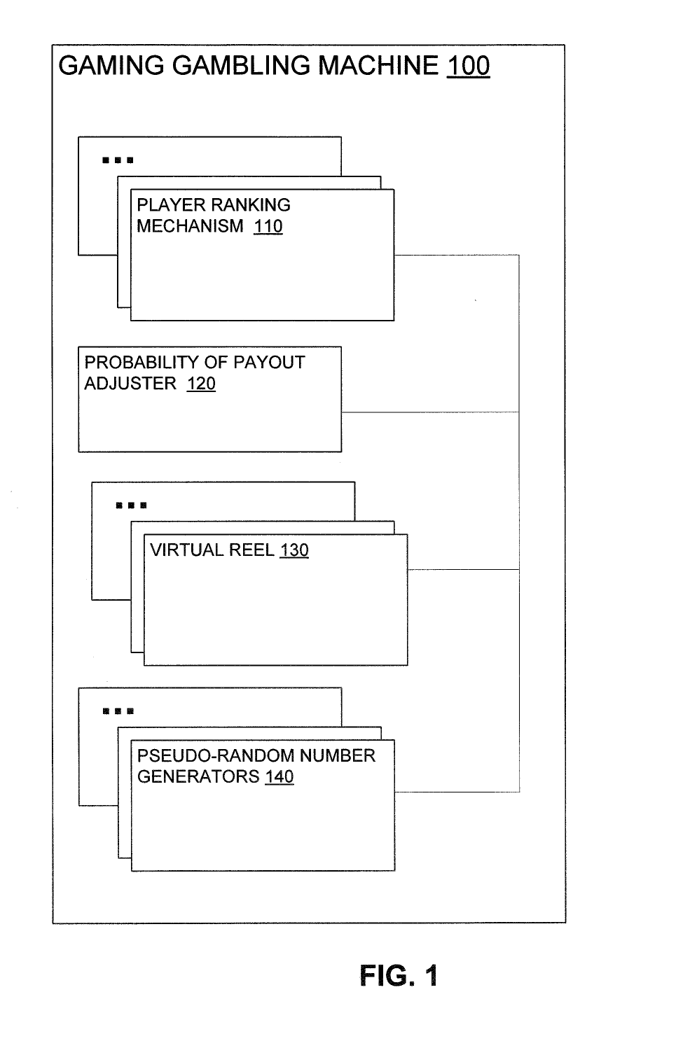

FIG. 1 is a block diagram illustrating one embodiment of a gaming gambling machine or gaming gambling machine or a skill-based video gambling machine. Depending on the embodiment, certain of the blocks described below may be removed, others may be added. FIG. 1 includes a set of Player Ranking Mechanisms 110 in electronic communication with a Probability of Payout Adjuster 120, a set of Virtual Reels 130, as well as a set of Pseudo-Random Number Generators, though other embodiments could be used, as well as a method for constantly changing throughout and with each new game the ranges of a probability of payout for the worst to best scoring players at all of each game's payout opportunities. For example, the Gaming Gambling Machine System 100 may include multiple Probability of Payout Adjusters 120 and one or multiple Player Ranking Mechanisms 110, and with probability of payout rate ranges that change with each game and can be randomly or randomly changes with each new single game played.

Player Ranking Mechanism

In one embodiment, the Player Ranking Mechanism (“PRM”) 110 is a module configured to rank or score players that are playing a game. The PRM 110, along with GGMs 100, can be configured to rank players playing any contemplated video game. In some embodiments, the PRM 110 can work with any video game where scores by players can be rank ordered from best scores to worst scores, such as, ranked from as little as 1 to 10, to any larger number set of player rankings, and the ranked scores of players can include current and/or past players of a single GGM or current and/or past players of multiple GGMs connected in simultaneous real-time via the Internet or any other GGM connecting systems or a network. For example, the PRM 110 can work with all types of video racing games, a car or motorcycle race, a skiing race, a decathlon, a running race, or any type of race where a player is trying to reach a certain point or level as fast as they can, and of course, in all video games where scores of gamblers can be rank ordered.

In some embodiments, each PRM 110 within the GGM 100 influences a chance of a monetary payout for the GGM's player, and the payouts can occur many times during any one single video game race or other game and not just at the end. For example, with a racing game where the average player would finish the entire race in a total duration of 3 minutes or say 5 minutes, a PRM 110 can be engaged to modify the ranking of one or more players at all spots where it takes the average player 5, 10, or even 20 seconds to cross. With such racing games this can be done by creating unseen lines across the track of the race course of the video game wherein each player's passing time for each line or for reaching a goal is compared to other player's passing time to cross each of the same lines or reach each goal, respectively, and at the end of the race tracing from the start of the race. In some embodiments, the scores of each player can be increased or decreased as the video version of the player strikes or is struck by various objects throughout the video game. As each line is crossed or each goal reached, a time is clocked and the PRM 110 can be engaged and simultaneously, or virtually simultaneously, a new clock can be started that will lead to the next PRM 110, and at the end of the race a final PRM 110 ranks the players. Thus, there can be multiple PRMs 110 in each GGM 100 and/or there can be a single PRM 110 with multiple interim ranking spots or goals. In some embodiments, every GGM 100 will have a time limit on each individual play of the GGM 100, unless more money or the like is added to the machine by the player in order to continue more play.

A PRM 110 can also work with any other type of video game competition wherein players can be rank ordered as to how well they score compared to other players, such as sports games, single player games with scores, or multiplayer tournament games. For example, in a American football video game, the PRM 110 can be engaged at the end of each offensive play that is made by the players, players can be rank ordered as to how well they play using how many yards they gain or lose in a play or how quickly a player scores a touchdown relative to past players. With a soccer game, for example, plays can be rank ordered using and valuing how much time the player controls the ball, how much time the player controls the ball on the opponents side of the field, depending on how close to the opponents goal, such as by inserting seen or unseen lines on the video screen, how many shots on goal, how many goals are scored, and/or how quickly goals are scored by both the player and his or her past or present video opponents. In some embodiments, PRM 110 could set the score of each player as a function of the score of the team the player is playing for, but PRM 110 preferably sets the score of each player as a function of the entirety of that player's performance during the game, and/or during a time period of the game in addition to the team's score. The variety and type of video games wherein scores by players can be rank ordered for purposes of the PRM 110 and GGMs 100 is unlimited.

In some embodiments, the number of scores rank ordered can vary from as little as ten (10) to all scores ever played on each individual GGM 100 and connected groups of GGMs 100 being played simultaneously and/or otherwise. As one example embodiment, a GGM 100 using a rank order of 121 scores will be discussed further herein. In this embodiment, these 121 scores are acquired sequentially. That is, as each new score is undertaken by the PRM 110, the oldest played score of 121 scores is eliminated from the group of 121 scores. Once that is done, the GGM 100 engages in a payout analysis. In another embodiment, a limitless number of GGMs 100 using a rank order of 121 scores can be linked together, via the Internet, any functionally similar system, or a network, such that players will be scored against other current players in real-time. The user interface for each GGM could be located distally from one another in different locations along a wall, in different locations in a building, or even in different buildings altogether.

In some embodiments, the GGM could be configured to gather scores from players into groups of 121 scores, with any remainder being grouped with the most recent past scores, and simply continuing on to the Probability of Payout Adjuster as discussed below. The selection of the groups of scores may be done randomly or in a non-random manner, such as by selecting players that want to play against each other, by selecting players based on particular criteria, and so forth. The GGM 100 can also form groups in the manner discussed herein using groups of any number. Also, at this point players can be grouped into various groups for tournament style play.

Each GGM could be configured to play the same game, or could be configured to play different games. For example, some GGMs could be configured to a racing game, while others are configured to play golf games, and others are configured to play racket games. The scores of all players could be aggregated and ranked. In some embodiments, scores from various games could be normalized with one another so that a score from one game can be easily compared to a score from another game. In this manner, the system could weight the scores of some games more than others, for example by providing more weight to a game that requires more skill, or providing more weight to a game that was randomly selected to have more weight. In other embodiments, additional weight could be applied to a game or a player who has contributed larger bets within a certain time period.

Probability of Payout Adjuster

In one embodiment, the Probability of Payout Adjuster (“PoPA”) 120 is a module configured to electronically and automatically conduct payout analyses. In some embodiments, the PoPA 120 is configured to execute a, for example, roughly eight step mathematical calculation that ensures that GGMs 100 maintain overall monetary payout rates, such as, for example, average payout rates similar to contemporary slot machines. As one example, embodiment, PoPA 120 could be configured to ensure that GGM 100 has an average payout rate of 97%, which means that for every dollar that is spent playing the GGM 100, on average this GGM 100 will payout 97 cents.

As used herein, a “payout rate” comprises the average amount of money a player earns by playing a game an infinite number of times. The payout adjuster could alter the payout rate of a player in several ways, such as by altering the potential payout for a win or by altering the odds of winning. For example, if a player is playing casino war, he has a 46.3% chance to win 2× his bet, giving the player a payout rate of 92.6%. If the system tries to increase the player's payout rate to 110%, the system could dictate that the player wins 2.4× his bet when the player wins, or the system could prevent the dealer from playing Aces. Likewise, if the player is playing a slot machine, the system could alter the potential payout for each line, or could eliminate low-scoring fruit or “bust” fruit (to increase the payout rate) or introduce low-scoring fruit or introduce more “bust” fruit (to decrease the payout rate).

The PoPA 120 may be used with GGMs 100 for two reasons, which add unique and original functionality to GGMs. For example, the ranking of scores through the PRMs 110, without a PoPA, would mean that the overall payout rate of that GGM may not be predictable and it may actually be above 100%—thus causing a GGM machine operator a loss of money. One reason this would occur is because the more that people play specific video games and therefore also each GGMs 100, the better they will each play and score. This is true for both individuals generally, as well as groups of people generally. This phenomenon is referred to herein as the Play Improvement Phenomenon (“PIP”). The PIP could ensure that scores will likely not fall within perfect or even mathematically appropriate bell curve distributions.

A perfect or mathematically appropriate bell curve distribution of scores could occur if by the odd chance that, for example in a GGM with 11 groups of 11 scores, over 121 scores, each new score that enters the rolling count of 121 scores enters a group of 11 about the same relative period that an older score is exciting that group of 11 because it is no longer part of the past 121 scores. In other words with this example, over 121 scores, each group of 11 scores has exactly 11 scores enter it's group as it is the newest score of 121. If such an odd occurrence were to occur, the PoPA 120 would not be needed and each group of 11's Equal Payout Rate would become that group of 11's Second Payout Rate. Therefore, a perfect or mathematically appropriate bell curve is also reflected in the Equal Payout Rates in the examples in this patent, all of which, if they could occur would lead to perfectly predictable overall payout rates that are also below 100%. However, the PIP ensures that the EPRs cannot be relied on to insure perfectly predictable overall payout rates that are also below 100%. But the PoPA insures that GGMs have perfectly predictable overall payout rates below 100% once they are then connected to the Second Payout Rates and Virtual Reels. The other primary purpose of the PoPA is so that, given that the skill levels of video game players can vary greatly and over long periods of time, the PoPA ameliorates these skill differences as they are reflected in Second Payout Rates and then Virtual Reels, thus allowing GGMs to operate overtime more often as advertised in the sense that above average scoring players should acquire payout rates above 100%, in other words where they can beat the house, but where overall payout rates are generally predictable and below 100%.

The GGM is generally configured to derive each Second Payout Rate closer to the average ideal payout rate (typically set by an administrator of the GGM). For example, if the average ideal payout rate is 97%, the GGM derives each Second Payout Rate to the closer to 97% the more that a group of scores (e.g. 11 scores) has more than 11 scores enter its group just as it becomes a brand new score of the 121 scores. In this way, the system could ensure that past scores, past potential payout rates, the Player Ranking Mechanism, and the PoPA math formula all affect future payout rates.

The PoPA 120 may be used with GGMs 100 because the ranking of scores through the PRMs 110 may not fall within perfect or even mathematically appropriate bell curve distributions. This is because the more that people play specific video games and therefore also each GGMs 100, the better each person will probably play and score. This is true for both individuals generally, as well as groups of people generally. This phenomenon is referred to herein as the Play Improvement Phenomenon (“PIP”). In some embodiments, PoPA 120 could be configured to compensate the PIP by keep the average monetary payout rate of each GGM 100 extremely close to or even virtually close to the rate that is intended. An administrator user preferably sets the average monetary payout rate through an administration user interface (not shown). However, the PIP ensures that the EPRs cannot be relied upon to ensure perfectly predictable overall payout rates that are also below 100%. But the PoPA is configured to ensure that GGMs have perfectly predictable overall payout rates below 100% once they are then connected to the Second Payout Rates and Virtual Reels, for example by normalizing the ranks of each of the players to a bell curve, or by forcing player groups to have certain numbers. For example, in one embodiment all players might achieve the exact same score. In that situation the PoPA could be configured to randomly pick which players belong in certain groups to ensure a bell curve distribution.

Another purpose of the PoPA is so that, given that the skill levels of video game players can vary greatly and over long periods of time, the PoPA could be configured to ameliorate these skill differences as they are reflected in Second Payout Rates and then Virtual Reels, thus allowing GGMs to operate more often over time as advertised in the sense that above average scoring players should acquire payout rates above 100%, in other words where they can beat the house.

Virtual Reel

In one embodiment, the Virtual Reel 130 is a display module configured to display various output values to a player and/or to send instructions to a display. For example, a Virtual Reel 130 may include a display that is an electronic depiction of a physical slot machine reel with a certain number of stops, where different stops represent different payouts. The display may include various displays that mimic existing gambling machines, video game screens, gaming screens, or other screens. In addition, the Virtual Reel 130 may be configured to send control signals to an actual physical component that presents the outcome of the game, such as a control signal that is sent to a motor that controls an actual wheel of a slot machine, a motor that controls miniature horses that are running a race on a simulated or miniature race track or car or motorcycle track, a processor that controls a miniature football player that is located on a simulated or miniature football field, and so forth. The GGM's 100 use of Virtual Reels 130 is discussed further below.

Example Use of Probability of Payout Adjuster

The following provides an example embodiment use of a PoPA 120 within a GGM 100 wherein the top 9.1% best players of this GGM 100 will have on average a 3.13 times larger monetary payout rate than the 9.1% worst players. Although these specific numbers are being used for this example, it is recognized that with GGMs 100 and the related math, the chance of winning between best and worst scores, and all those in between, can be made virtually as large or as small as desired. Using the prior example of a total group of 121 scores, the 121 scores are divided into 11 groups of 11 scores. In this embodiment, the 121 scores represent a sequential grouping of the 121 scores that is ranked from the best score of 121 to the worst score of 1. In addition, as a new score is entered into the GGM 100, the score that was entered earliest into the GGM 100 121 scores is eliminated from the grouping of 121 scores.

With this example of GGM 100, the top group of 11 scores without the PoPA 120 will have an average payout rate of 147%. The 2nd best group of 11 will have an average payout rate of 137%. The 3rd best a 127% payout rate. The 4th best a 117% payout rate. The 5th best a 107% payout rate. The 6th best a 97% payout rate. The 7th best an 87% payout rate. The 8th best a 77% payout rate. The 9th best a 67% payout rate. The second to last group of 11 a 57% payout rate. The worst group of 11 scores a 47% payout rate. The average payout with this GGM 100 is 97%. However, all of the above percentages are very likely to be changed with the PoPA 120 calculation primarily due to the Play Improvement Phenomenon. The above payout rates for each of the 11 groups of 11 scores are called their Equal Payout Rate (“EPR”). Each group of 11's EPR will likely be adjusted by the PoPA 120 due primarily to the PIP, and that outcome will be each group of 11's Second Payout Rate.

GGMs with average overall payout rate of 97% could also have Equal Payout Rates that range from the worst group of 11 scores of 75%, 79.4% for the second to worst group of 11 scores, 83.8% for the next best group of 11 scores, 88.2% for the 4th to lowest group of 11 scores, 92.6% for the 5th to lowest group of 11, 97% for the middle group, 101.4% for the next best group of 11 scores, 105.6% for the next group, 110.2% for the next better scoring group, 114.6% for the second to top scoring group, and 119% for the top scoring group.

Using the above first example of the embodiment, the PoPA 120 is configured to execute a roughly eight step mathematical equation to govern the payout rates. In order to increase the amount of time that a GGM while in play functions with payout rates above 100% and where most of the above average players achieve payout rates above 97% and below average scoring players achieve payout rates below 97%, in other words where the game is not “bottomed out” so to speak, a mathematical calculation is employed with each individual score and each individual payout opportunity in each individual game or otherwise, that keeps the GGM from being more likely to bottom out while ensuring that the GGM over time has an average payout rate of, for example 97%, or extremely close to it.

This math calculation is as follows:

First: When the newest score of 121 scores, that are rank ordered from 1 to 121 with 121 being best, is rank ordered into one of the 11 groups of 11 scores, the PoPA 120 takes the exact number of first time, newest scores that have fallen into that particular group of 11 scores over the past 121 scores and subtracts 11 from that number. Step two: If the exact number of newest scores ranked into a particular group of 11 is equal to or under 11, then the newest score's Second Payout Rate is this score's group of 11, Equal Payout Rate. But if this number is greater than 11, then multiply the amount over 11 number by −0.1. Then multiply the number derived from the last step in the last sentence by the difference between 97 and the newest score's group of 11, Equal Payout Rate made into a whole number. Step three: If the newest score of 121 scores is ranked in one of the top 5 ranked groups of 11 scores, then add the number derived from step two to the Equal Payout Rate of that group of 11 made into a whole number. Then convert the number derived from the last step of the last sentence into a percentage and this will be this newest of 121 scores Second Payout Rate. If the newest score of 121 scores is ranked in one of the bottom 5 ranked groups of 11 scores, then convert the number derived from step two into a positive number. Then add the number derived from the last step to the Equal Payout Rate of the newest score's group of 11 made into a whole number. Then convert this number to a percentage. If this percentage is 97% or below when this newest score is ranked into one of the the lowest 5 groups of 11 scores or if the percentage is 97% or above when this newest score is in the top 5 groups of 11 scores, then this percentage is this newest score's Second Payout Rate, if not, or if this newest score is in the middle group of 11 scores, then 97% is this newest score's Second Payout Rate, in this example.

Using the numbers in the above example of the embodiment, suppose a newest score falls into the 3rd to top group of 11 scores, meanwhile over the past 121 scores the 3rd to top group of 11 scores has had 15 newest scores fall into their group. To start the PoPA 120 calculations, as a newest score is made in the GGM 100, the score made 121 scores prior is eliminated from the group of 121. The remaining 121 scores are then ranked from 1 to 121 with 121 being the best score and 1 the worst. These 121 scores are then placed into 11 groups of 11 scores. Then, this newest score is given its group of 11's Equal Payout Rate. For the 3rd to top group of 11 scores in this GGM 100 this is 127%. Therefore, (((15−11)=4)×−0.1)=−0.4×30 or (127−97)=−12)+127=115 or 115%. 115% is this newest scores Second Payout Rate, and this SPR is then sent to the GGMs 100 numerically nearest Virtual Reel 130.

Another example, if the 2nd to top scoring group of 11 with an Equal Payout Rate of 137% has 13 of the 121 newest scores: This would mean: (((13−11)=2)×−0.1)=−0.2×40 or (137−97)=−8)+137=129 or 129%.

Once the system derives a payout rate for a player, the system could alter the potential payout for the player and/or alter the odds of winning for that player in order to satisfy the derived payout rate. For example, where a player has the default odds of winning 3× of his bet 20% of the time, the player has a payout rate of 60% (20%×3). If that player then scores high enough, the system could derive a new payout rate to be 120%. When that occurs, the system could alter the potential payout for the player by setting that the player could win 6× of his bet 20% of the time (20%×6=120%). The system could alternatively alter the odds of winning for that player by setting that the player could win 3× of his bet 40% of the time (40%×3=120%). In other embodiments, the system could later both the potential payout and the odds of winning, by setting that the player could win 4× of his bet 30% of the time (30%×4=120%). In embodiments where a player is playing a slot machine using a virtual reel, the system could configure each player's virtual reel to have a payout rate specific to that player that is either exactly equal to the player's payout rate, or more likely within a tolerance of the player's payout rate (e.g. within 0.5%, 1%, 2%, or 5% of the Second Payout Rate). When a new score is made, the system could derive a Second Payout Rate that corresponds to a new virtual reel, which produces a payout rate that is either exactly equal to the Second Payout Rate, or more likely within a tolerance of the Second Payout Rate (e.g. within 0.5%, 1%, 2%, or 5% of the Second Payout Rate). An administrator user could configure a GGM to have a degree of accuracy within such a threshold, such that the GGM could develop a virtual reel having a payout rate of 122% to a player with a derived payout rate of 122.3% where the threshold is 0.5%. The number of payout opportunities in any single GGM game is preferably configured such that the virtual reel payout rates are divided by the number of payout opportunities for any single GGM game, such as in the 120% examples stated above.

In some embodiments, the GGM could be configured to aggregate past payout rates across a period of time in addition to the present scores of the players accessing the GGM. For example, the GGM could analyze all payout rates in the last hour, and disperse payout rates to all new players so that all payout rates for all players within in the last hour is at 97%, 95%, or 90%. In other embodiments, the system could be configured to alter the payout rate of a player as a function of previous actual money paid out over time. By aggregating payout rates and/or previous payments across a plurality of players over time, instead of just the players presently playing the game, the GGM could introduce “lucky” ebbs and flows into the payout rates, such that the system ensures that large groups of players have payout rates over 100% for a period of time, followed by large groups of players having payout rates below 100% for a period of time. In some embodiments, the system could be configured to artificially inflate a group of player's payout rates for a period of time in response to a triggering alarm, for example when the system detects that a threshold number of players is likely to walk away from the machine. The system could monitor players' playing patterns over time to determine the average number of consecutive losses a player suffers before getting up to walk away from the machine. The system could then trigger an alarm when the player hits that threshold period of time, or could trigger an alarm when a group of players hits an average of the group's threshold period of time.

Pseudo-Random Number Generators

Pseudo-Random Number Generators (“PRNGs”) 140 are modules configured to execute mathematical formulas that, when repeated, generated extremely random number sequences. PRNGs 140 are very regularly used in many things. Many modern computerized slot machines include a single PRNG 140. However with GGMs 100, in some embodiments, the GGMs 100 include two PRNGs 140 using them in a way different than in modern computerized slot machines.

Here's an example of a simple pseudo-random number generator formula:

{random_seed=random_seed*1103515245+12345; return (unsigned int)(random_seed/65536)% 32768;}

This formula assumes the existence of a variable called random_seed, which is initially set by use of a random number. The random_seed variable is then multiplied by 1,103,515,245, and then 12,345 is added to that product. A new random_seed is then replaced by this new value.

A variation of the above formula is to use only the bottom six digits as the next random_seed as the random_seed is generated by the formula. In some embodiments, this modified formula can be used by a PRNG 140 in the GGM 100. In one embodiment, with the first PRNG 140, the first random_seed is 759, although other numbers could be used.

Within each GGM 100, the computer processor within the GGM 100 can be constantly and rapidly repeating the first PRNG 140 mathematical formula, as is the case with PRNGs 140 in modern slot machines. The first PRNG 140 can be running, even when no person is playing or even touching the GGM 100. Then, after the computer processor in the GGM 100 acknowledges that someone has inserted money or the like to play the GGM 100, the random number that is generated from the first PRNG, or in other words the last random_seed of the first PRNG, becomes the first random_seed of the second PRNG. The entire time that this person in playing this GGM 100, or until they put in more money because they must to continue to play, the second PRNG 140 mathematical formula can be constantly running at a very rapid speed, such as, for example, as rapid a speed as possible for that computer processor.

At this point within the GGM 100, after the GGM 100 acknowledges that the player has moved past the first Player Ranking Mechanism and thereby then setting off the first PoPA 120 mathematical formula calculation, after this happens, the second PRNG 140 generates a 2nd Most Important Number. However, at the same time, the first PRNG 140, which is always running, can also be used to generate a second random_seed number for the second PRNG 140 to restart the second PRNG 140 in preparation for the second Player Ranking Mechanism 110 and second PoPA 120.

Exemplary Use of Pseudo Random Number Generators

Returning to the example, the first 2nd Most Important Number is generated by the second PRNG 140 with the first PRM 110 and first PoPA. This number can be divided by a number, such as 64. In some embodiments, 64 is used as the number because 64 is commonly used within the Virtual Reels 130 of modern slot machines. However, unlike modern slot machines that only have one Virtual Reel 130 per machine, embodiments of the GGM 100 can have multiple Virtual Reels 130, such as, for example, 300 Virtual Reels 130. It is recognized that the number of Virtual Reels 130 in a GGM 100 or used with a GGM 100 can vary greatly depending upon the degree of accuracy that is desired concerning the GGM's 100 overall average payout rate.

Returning to the example where the 2nd Most Important Number is divided by 64, as one example, the first 2nd Most Important Number may be 376,508, which divided by 64 (that is 376,508/64) results in 5882 with a remainder of 60. The important number that is derived from this calculation is the remainder of 60. This remainder of 60 becomes the Most Important Number that is generated by the two PRNGs 140.

In some embodiments, this remainder number 60 then corresponds in the GGM's 100 Virtual Reel 130 to one of 64 boxes in a table of 64 boxes that each reveal a potential monetary payout to the player. Each of the 64 boxes that make up one GGM's 100 Virtual Reel 130 can be given a monetary payout amount, or more likely no payout amount. In some embodiments, the payout is similar to a slot machine, where for every dollar that is spent playing the slot machine or GGM 100, 97 cents will be paid out for every dollar spent playing resulting in a payout rate of 97%. However, unlike with modern slot machine Virtual Reels 130 where there is only one payout per play, in some embodiments, the 64 boxes in the GGM's 100 Virtual Reels 130 can be divided by each PRM per game.

In some embodiments, the Virtual Reels 130 are made up of a table of 64 boxes. The 2nd PRNG 140 will derive a Most Important Number that will be from 1 to 64 that will tell the computer which one of the 64 boxes to choose. Each of the 64 boxes in each Virtual Reel 130 will have a monetary payout amount in it that will most often be zero but will also at times show a given monetary amount. This monetary amount, if any, is than presented to the player as winnings. With the example above, the 64 boxes of the Virtual Reels 130 are given monetary payout amounts, if any, such that, each Virtual Reel 130 can have total payout rates that are different and vary greatly due to the distribution of the 1331 possible Second Payout Rates that can occur with 11 groups of 11 scores.

In some GGM embodiments, for example with a racing game with four different Probability of Payout Percentage Rate Ranges, 75% to 119%, 80% to 114%, 86% to 108%, and 91% to 103% for worst to best players, such a GGM can have as little as 205 Virtual Reels and such a GGM over time will have an average overall payout rate that is exactly 97%. The exact same GGM can also have no more than a 0.05% deviation from 97% with no more than 129 Virtual Reels 130. Yet since Virtual Reels are created by using a relatively very tiny amount of computer code and memory, the number of Virtual Reels in each GGM is insignificant outside of the degree of predictable accuracy that is desired for the GGM. The relative position of each player could determine the score for each player.

How a player's first score ranks with the first Player Ranking Mechanism 110 and first PoPA 120 affects his or her first Second Payout Rate. His or her SPR is then related to one of, for example, 205 Virtual Reels 130 in the GGM 100, with the payout percentage that is exactly the same, or in other examples, numerically closest.

Using an example of a GGM embodiment, the Second Payout Rate may be 103.6%. The Virtual Reel 130 is found on the table of 205 Virtual Reels 130 that has a payout rate of 103.6%, or in some embodiments, the closest payout rate to 103.6%. This numeric precision is due to the 205 mathematical possibilities that 11 groups of 11 scores in the example ranges present here and our ability to place as many Virtual Reels 130 as wanted and wherever they are wanted. What this means is that the Virtual Reel 130 with the 103.6% payout rate will be engaged such that the number 60 will be sent to the 60th box in the table of 64 boxes that make up the 103.6% Virtual Reel 130. If that 60th box has in it a payout amount, then that payout amount will be displayed to the player as winnings using the GGM's 100 payout mechanism.

In some embodiments, the Virtual Reels 130 have, for example 205, different payout rates that range from a 75% payout rate to a 119% payout rate. Yet the GGMs 100 may also account for how often the Player Ranking Mechanism is engaged. That is, while with a modern slot machine a Virtual Reel 130 with 64 boxes that creates a payout rate of 97% is only engaged once for every time it is played, the amounts of money that are in the boxes within the tables of the Virtual Reels 130 within the GGMs 100 can be divided by the number of Player Ranking Mechanism 110 and PoPA 120 calculations within the GGM 100 for every dollar or credit played. For example, with some embodiments of the GGM 100, if for every one full play of the GGM 100, 10 PRMs and PoPAs 120 are engaged and therefore 10 separate times a player will have a chance to win a payout, the Virtual Reel 130 with a 75%% payout percentage will be cut to 7.5% and the 119% Virtual Reel 130 will be cut to 19.9%, or the 103.6% Virtual Reel will be cut to 10.36%. Therefore with such GGMs 100, the payout rates of each of the Virtual Reels 130 can be adjusted relative to the amount of PRMs 110, PoPAs 120, and chances of a payout.

With some GGM embodiments, gamblers can increase the probability of payout percentage rates for each payout opportunity of each single GGM game or race by increasing the amount that they bet. That is, players can increase the GGMs average overall payout rate from, for example 95% to 98% with increased betting amounts. This is done by shifting each group's of 11, Equal Payout Rate up or down by 4% points depending upon how much is bet by the player. Such a GGM with four bet options that would overtime create four different average overall payout rates of 95%, 96%, 97%, and 98%, and with four different P.o.P.P.R Ranges exactly like those described above could have as few as 255 Virtual Reels and no more than a 0.05% deviation from the expected overall payout rate would occur. Therefore, with this GGM option of increasing or decreasing overall payout rates by increasing betting amounts requires an increase in the number of Virtual Reels in the GGM.

Probability of Payout Percentage Rate Range Changes

In some embodiments of GGMs, including the racing game example in this patent submission, the payout percentage rate ranges for each payout opportunity, with each new single full race or game played, can be changed and in any random or nonrandom pattern. That is for example, if there exists 20 payout opportunities within one play option of a GGM racing game or other type of GGM video game, the probability of payout percentage rate ranges for each of the 20 payout opportunities can be altered with each new single game played. For example, the probability of payout percentage rate ranges of 47% to 147% and 75% to 119%, for worst to best scoring players that was explained earlier in this submission, among others, can be altered from any range, in the embodiment of 11 groups of 11 scores with the Player Ranking Mechanism and Probability of Payout Adjuster, can be as broad as possibly as low as 5% for the worst scoring players to possibly as high as 1617% for some of the best scoring players in some embodiments of GGMs, or any mathematically appropriate range smaller.

For example, all 20 payout opportunities of a GGM racing game can have one of four different payout percentage rate ranges that can be varied with each new single game gambled. For example the four different ranges could be 75% to 119% for worst to best players, as well as 80% to 114% range, and 86% to 108%, and 91% to 103%. There can exist any number of probability of payout percentage rate ranges. However, each new range, at each different payout opportunity, requires it's own Player Ranking Mechanism, of in this embodiment 121 scores, and a Probability of Payout Adjuster to work with each PRM, before the closest Virtual Reel is then engaged, as described earlier in this submission.

The variability of Probability of Payout Percentage Rate Ranges with each new single GGM race game played, requires that that GGM contains it's own P.o. P.P.R. Range Virtual Reel. This virtual reel will have, 64 for example in this embodiment, or more or less, different patterns of P.o.P.P.R Ranges that could occur with each of the different payout opportunities that are in each individual GGM game or race. With each new single GGM game or race played, this P.o.P.P.R. Range Virtual Reel is engaged by the first Pseudo Random Number Generator that creates a random number the split moment that the gambler makes a final game or race bet option.

One of the functions of GGM P.o.P.P.R. Range changes is so that GGMs can not be manipulated by the most skilled of players in a way that makes them less appealing for other potential gamblers to play, among other manipulations, as well as making GGMs less predictable and more exciting, while giving lesser skilled players better probabilities of payouts even as play continues and even as they play less and less well relative to other past or current players of that GGM.

Example of GGM Racing Game

Using one embodiment of a GGM racing game, a player/gambler sits on a full replica of a motorcycle. The video screen in front of the player shows scenes from the motorcycle racing game, along with various gambling options with different gambling amounts, and average racing times for various racing options, along with the various payout possibilities.

In some embodiments players will have the option to increase all of the probability of payout percentage rates with every payout opportunity with each single GGM game played by increasing the amount players bet. This is done by using all existing Player Ranking Mechanisms and the same Probability of Payout Adjuster, but using higher and lower Equal Payout Rates within the Probability of Payout Adjuster mathematical formula depending upon bet amounts. Also, more Virtual Reels will need to be added to the GGM, and an example of this and earlier processes are described earlier in this submission.

The player/gambler chooses a gamble option via a button that is easily accessible to the right thumb of the player while holding the right handle bar of the replica motorcycle. Once an option has been made, and some form of payment has been made, the first Pseudo Random Number Generator, that has been running consistently once the GGM is plugged in and initially started, produces it's last Random Seed. This last random seed number is sent to the P.o.P.P.R. Range Virtual Reel, thus generating a payout rate range pattern for the single racing game that is about to be played. In such an embodiment, the potential player could be shown various gambling and wagering options for play time and wager amounts, among other things, on the video screen in front of the potential player. When, or shortly after, a gambling and play option is made by a player via a button that is accessible to the right thumb of the racer as he or she holds the motorcycle handle bar, the first Pseudo Random Number Generator, that has been running consistently once the GGM is plugged in and initially started, could be electronically activated and the PRNG produces it's last Random Seed. This last random seed number is sent to the P.o.P.P.R. Range Virtual Reel, thus generating a payout rate range pattern for the single racing game that is about to be played. Then a few seconds later, as the video motorcycle racer moves across the starting line, a second random seed is generated from the 1st P.R.N.G. This second random seed becomes the first random seed for the second P.R.N.G., which will be used for the races first payout opportunity.

As the racing game begins and the video game version of the player's motorcycle crosses a line, hidden or otherwise, a clock begins that is connected to the Player Ranking Mechanism. Then about the moment that, at an earlier chosen spot estimated to be the point at which it would take the average racer, in this example 7 seconds, to reach, the video motorcycle will pass a hidden, or otherwise, line within the video game activating the previously mentioned clock that will create a first time score for the players first payout opportunity. This first score will then be undertaken through the Player Ranking Mechanism, then the Probability of Payout Adjuster, then the appropriate Virtual Reel using what is derived by using the second random seed from the first P.R.N.G. as the first random seed for the second P.R.N.G.

In other embodiments of GGMs, the score, that is rank ordered through the Player Ranking Mechanism can be increased or decreased by the player/gambler through the video game, for example, throwing a pie or shooting a gun, and striking an object or person; or that video person or object striking the video version of the player.

Once the score of the first payout opportunity is completely calculated, and the time that was clocked for the first score for the first payout opportunity marks the starting time for the second score for the second payout opportunity, and so on as the racing game continues, the Player Ranking Mechanism, Probability of Payout Adjuster, Virtual Reels, Pseudo Random Number Generators, and even eventually if the gambler continues to play, the P.o.P.P.R. Range Virtual Reel, could all be engaged as described above in response to a triggering mechanism, for example the player activating another bet. As the racer/gambler goes through all payout opportunities within the GGM video game, as the player is either finished with, or close to finished with all of the single game's payout opportunities, or at any other time within the game or race, the gambler is prompted to make an additional bet option and game and/or race option. At the moment this option is made, the first Pseudo Random Number Generator produces a new number that immediately activates the P.o.P.P.R. Range Virtual Reel, and the GGM system as described in this submission repeats.

Gaming Gambling Machine Platform

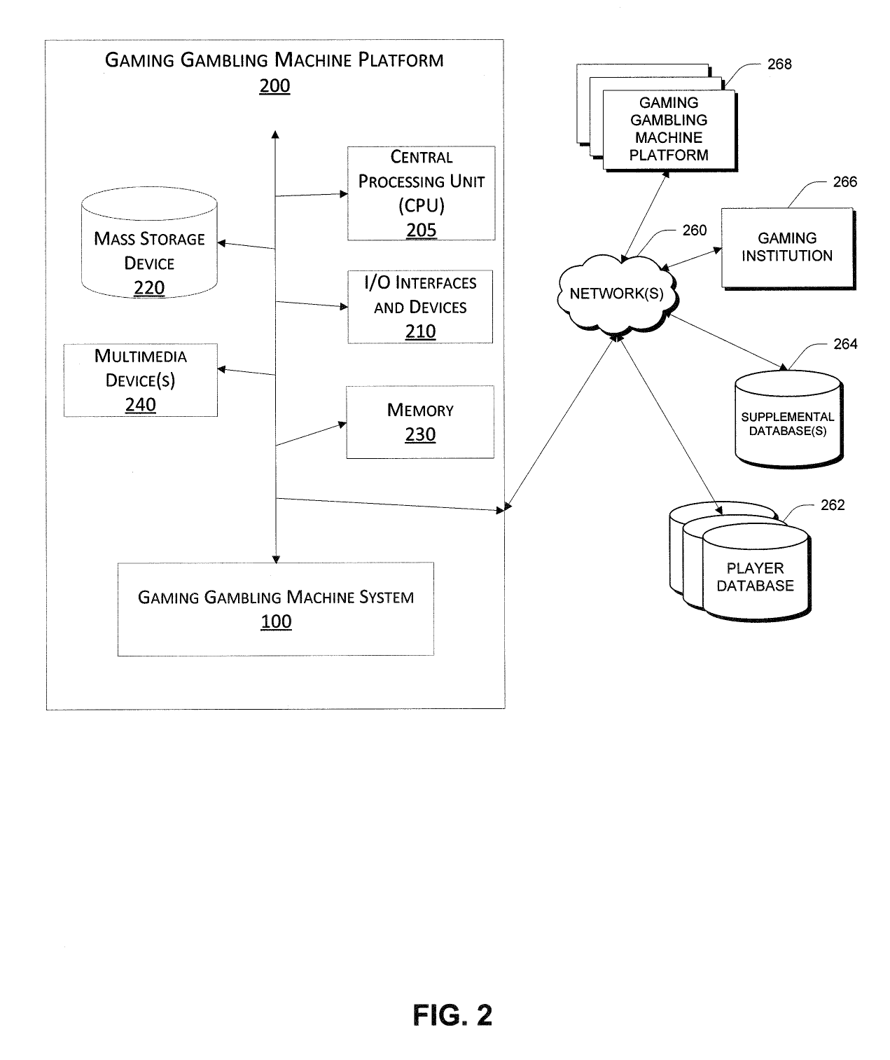

FIG. 2 is a block diagram showing one embodiment of a gaming gambling machine platform. The illustrated gaming gambling machine platform comprises a computing system 200 for conducting the gaming gambling (or simply “computing system 200”), that may electronically communicate over a network 260 with one or more player databases 262, a set of supplemental databases 264, a gaming institution 266, and/or other gaming machine platforms 268. The computing system 200 includes a central processing unit (CPU) 205, input/output (I/O) devices and interfaces 210, a mass storage device 220, a memory 230, multimedia devices 240, and a gaming gambling machine system 100.

The platform 200 may communicate with a first physical data store, the player database 262, which stores information about the past skills of various players, with a second physical data store, stored in the gaming institution system 266, and/or the supplemental databases 264, which may include additional information related to one or more gaming institutions. In addition, in some embodiments, the platform 200 may communicate in real-time with multiple institutions with multiple players over the Internet or a network. The information may include, for example past winnings for one or more players, skill levels, or the like.

In some embodiments, one or more of the databases may be implemented using a relational database, such as Sybase, Oracle, CodeBase, and Microsoft® SQL Server, as well as other types of databases such as, for example, a flat file database, an entity-relationship database, and object-oriented database, and/or a record-based database. The gaming institution system 266 may request skill information of a player from the computing system 200. Based on receiving information from the computing system 200, the gaming institution system may initiate communications with one or more players, such as to invite them to join the game or to make payouts.

The computing system 200 includes an gaming gambling machine system 100 that may be stored in the mass storage device 220 as executable software codes that are executed by the CPU 205. The gaming gambling machine system 100 may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. In the embodiment shown in FIG. 2, the computing system 200 is configured to execute the gaming gambling machine system 100 in order to generate, for example, player rankings as requested by gaming institution 266. The gaming gambling machine system 100 may also provide one or more of the features discussed above, including the ranking of players, as well as the determination of the probability of payout. In some embodiments, the computing system 200 illustrated in FIG. 2 may include fewer or additional components. For example, the computing system 200 may include a separate player ranking mechanism 110, or may not include multimedia devices 240.

Payout Calculation Process

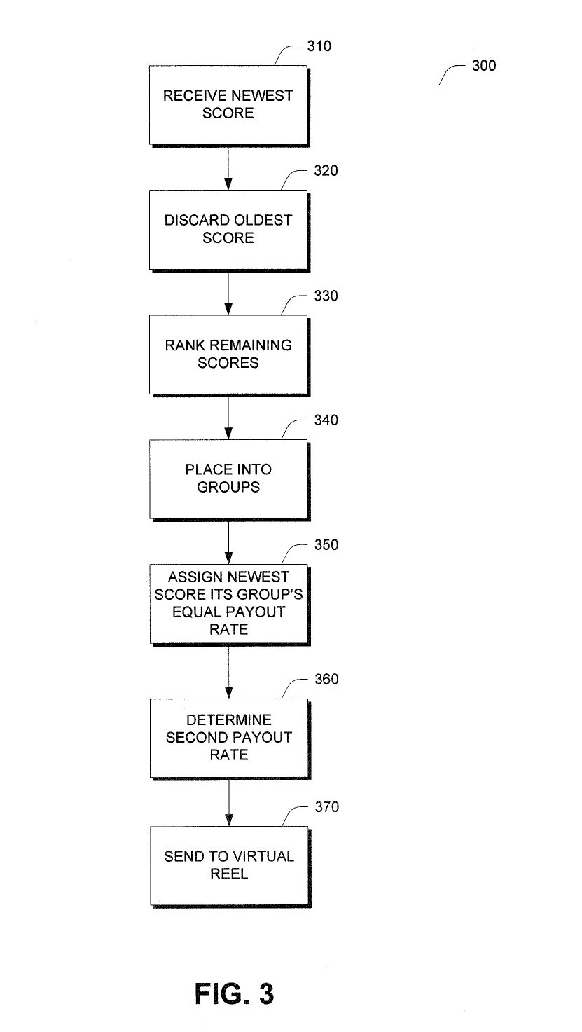

FIG. 3 illustrates one embodiment of a payout calculation process 300. The method may be stored as a process accessible by the gaming gambling machine system 100 and/or other components of the computing system 200. Depending on the embodiment, certain of the blocks described below may be removed, others may be added, and the sequence of the blocks may be altered.

Beginning in block 310, the system receives the newest score. Then, in block 320, the oldest score is discarded or eliminated from the group. In block 330, the remaining scores are then ranked, for example, from the best score to the worst or from the worst to the best. Then in block 340, the scores are then placed into groups. In some embodiments, the number of groups is predetermined, but in other embodiments, it is calculated. Then in block 350, the newest score is given its group's Equal Payout Rate. The newest score's Second Payout Rate is then determined in block 360. Then, the newest score's Second Payout Rate is sent to a Virtual Reel 130.

In some embodiments, the system does not perform all of the steps illustrated in FIG. 3. For example, the system may not determine the second payout rate, but send information to the Virtual Reel 130. In some embodiments, the processes illustrated in FIG. 3 may be performed by multiple systems working together with many times more than 121 players and playing simultaneously. For example, one system may rank the remaining scores in block 330, whereas another system may determine a second payout rate in block 360. In addition, in some embodiments, all or a portion of the process is processed in parallel and/or processed in parallel with the process for other players.

Computing System

The computing system 200 may include one or more computing devices, for example, a personal computer that is IBM, Macintosh, or Linux/Unix compatible or a server or workstation, desktop computer, a car computer, a mobile computer, or any other mobile device such as a mobile phone, smart phone, tablet or other similar handheld computing devices, and as noted above, the computing system 200 may be part of a larger system, such as a motorcycle, a climbing wall, a slot machine, and so forth connecting groups of players on the Internet, other system, or a network, or as a separate system for a single player. In one embodiment, the exemplary computing system 200 includes one or more CPUs 205, which may each include a conventional or proprietary microprocessor. The computing system 200 further includes one or more memory 230, such as random access memory (“RAM”) for temporary storage of information, one or more read only memory (“ROM”) for permanent storage of information, and one or more mass storage device 220, such as a hard drive, diskette, solid state drive, or optical media storage device. Typically, the modules of the computing system 200 are connected to the computer using a standard based bus system. In different embodiments, the standard based bus system could be implemented in Peripheral Component Interconnect (“PCI”), Microchannel, Small Computer System Interface (“SCSI”), Industrial Standard Architecture (“ISA”) and Extended ISA (“EISA”) architectures, for example. In addition, the functionality provided for in the components and modules of computing system 200 may be combined into fewer components and modules or further separated into additional components and modules.

The computing system 200 is generally controlled and coordinated by operating system software, such as Windows XP, Windows Vista, Windows 7, Windows 8, Windows Server, Unix, Linux, SunOS, Solaris, iOS, Blackberry OS, Android, or other compatible operating systems. In Macintosh systems, the operating system may be any available operating system, such as MAC OS X. In other embodiments, the computing system 200 may be controlled by a proprietary operating system. Conventional operating systems control and schedule computer processes for execution, perform memory management, provide file system, networking, I/O services, and provide a user interface, such as a graphical user interface (“GUI”), among other things. To implement the computing system 200 and/or one or more of its components, various software including Perl, Syncsort DMExpress, MySQL, InfoBright, Veritca, DB2 Connect,

Connect Direct, MapR M5 Hadoop, and/or Tableau can be Utilized.

The exemplary computing system 200 may include one or more commonly available I/O devices and interfaces 210, such as a keyboard, mouse, touchpad, and printer. In one embodiment, the I/O devices and interfaces 210 include one or more display devices, such as a monitor, that allows the visual presentation of data to a user. More particularly, a display device provides for the presentation of GUIs, application software data, and multimedia presentations, for example. The computing system 200 may also include one or more multimedia devices 240, such as speakers, video cards, graphics accelerators, and microphones, for example.

In the embodiment of FIG. 2, the I/O devices and interfaces 210 provide a communication interface to various external devices. In the embodiment of FIG. 2, the computing system 200 is electronically coupled to a network 260, which comprises one or more of a LAN, WAN, and/or the Internet, for example, via a wired, wireless, or combination of wired and wireless, communication link 215. The network 260 communicates with various computing devices and/or other electronic devices via wired or wireless communication links.

In general, the word “module,” as used herein, refers to logic embodied in hardware or firmware, or to a collection of software instructions, possibly having entry and exit points, written in a programming language, such as, for example, Java, Lua, C and/or C++. A software module may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events or interrupts. Software modules configured for execution on computing devices may be provided on a computer readable medium, such as a compact disc, digital video disc, flash drive, or any other tangible medium. Such software code may be stored, partially or fully, on a memory device of the executing computing device, such as the computing system 200, for execution by the computing device. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules described herein are preferably implemented as software modules, but may be represented in hardware or firmware. Generally, the modules described herein refer to logical modules that may be combined with other modules or divided into sub-modules despite their physical organization or storage.

It is also recognized that the term “remote” may include data, objects, devices, components, and/or modules not stored locally, that is not accessible via the local bus. Thus, remote data may include data on a device which is physically stored in the same room and connected to the user's device via a network. In other situations, a remote device may also be located in a separate geographic area, such as, for example, in a different location, country, and so forth.

### Additional Embodiments

Each of the processes, methods, and algorithms described in the preceding sections may be embodied in, and fully or partially automated by, code modules executed by one or more computer systems or computer processors comprising computer hardware. The code modules may be stored on any type of non-transitory computer-readable medium or computer storage device, such as hard drives, solid state memory, optical disc, and/or the like. The systems and modules may also be transmitted as generated data signals (for example, as part of a carrier wave or other analog or digital propagated signal) on a variety of computer-readable transmission mediums, including wireless-based and wired/cable-based mediums, and may take a variety of forms (for example, as part of a single or multiplexed analog signal, or as multiple discrete digital packets or frames). The processes and algorithms may be implemented partially or wholly in application-specific circuitry. The results of the disclosed processes and process steps may be stored, persistently or otherwise, in any type of non-transitory computer storage such as, for example, volatile or non-volatile storage.

The various features and processes described above may be used independently of one another, or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

All of the methods and processes described above may be embodied in, and partially or fully automated via, software code modules executed by one or more general purpose computers. For example, the methods described herein may be performed by the system 100 and/or any other suitable computing device. The methods may be executed on the computing devices in response to execution of software instructions or other executable code read from a tangible computer readable medium. A tangible computer readable medium is a data storage device that can store data that is readable by a computer system. Examples of computer readable mediums include read-only memory, random-access memory, other volatile or non-volatile memory devices, CD-ROMs, magnetic tape, flash drives, and optical data storage devices.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A gambling system, comprising:
a player ranking module configured to receive a set of scores from a set of players playing a gaming module;
a payout adjuster configured to alter payout rates for the set of players as a function of the set of scores and is configured to alter the payout rates from above 100% and below 100%; and
a gambling module configured to play a gambling game for each of the set of players as a function of the altered payout rates.

2. The gambling system of claim 1, wherein the gaming module comprises a racing game that determines the set of scores for each of the set of players by a relative position of each of the set of players.

3. The gambling system of claim 1, wherein the gaming module comprises a sports game that determines the set of scores for each of the set of players by a score of each team played by each of the set of players.

4. The gambling system of claim 1, wherein the player ranking module is configured to receive a set of most recent scores as the set of scores.

5. The gambling system of claim 4, wherein the player ranking module is configured to resample the set of scores by discarding an oldest score from the set of scores and adding a most recent score to the set of scores.

6. The gambling system of claim 1, wherein the player ranking module is configured to rank the set of scores and provide the rank of each of the set of scores to the payout adjuster.

7. The gambling system of claim 1, wherein the payout adjuster is configured to divide the set of players as groups of players, wherein each group in the groups of players has a different payout rate.

8. The gambling system of claim 1, wherein the gambling game comprises a virtual reel.

9. The gambling system of claim 1, wherein the gambling game comprises a slot machine.

10. The gambling system of claim 9, wherein the gambling game is configured to modify each potential payout for each of the set of players as a function of the altered payout rates.

11. The gambling system of claim 9, wherein the gambling game is configured to modify each odds of winning for each of the set of players as a function of the altered payout rates.

12. The gambling system of claim 9, wherein the payout adjuster is configured to transmit each of the altered payout rates to a corresponding virtual reel for each of the set of players.

13. The gambling system of claim 9, wherein the slot machine is configured to randomize the each reel using at least two pseudo-random number generators.

14. The gambling system of claim 1, wherein the payout adjuster is further configured to alter payout rates for the set of players as a function of a set of most recent payout rates.

15. The gambling system of claim 1, wherein the payout adjuster is further configured to alter payout rates for the set of players as a function of previous payouts to previous players that have already been disbursed.

16. The gambling system of claim 1, wherein the gaming module is configured to collect the set of scores from games played on user interfaces located in different buildings.

17. The gambling system of claim 1, wherein the gaming module is configured to collect the set of scores from different types of games.

18. A computer system, comprising:
a player ranking module configured to rank a set of players based on received scores for a gambling game;
a probability of payout adjuster configured to derive a probability of payout for the gambling game; and
a virtual reel configured to derive a payout amount as a function of a received score of the received scores related to a player of the set of players, at least two pseudo-random number generators, the derived probability of payout, and a payout rate.

19. A computer-implemented method for automated payout determinations, the method comprising, as implemented by one or more computing devices configured with specific computer-executable instructions:
saving a set of scores related to a gambling game and a set of players;
receiving a new score related to the gambling game and a player;
discarding an oldest score from the set of scores;
adding the new score to the set of scores;
ranking the set of scores to create a ranked revised set of scores;
assigning scores in the ranked revised set of scores to at least a first group of scores and a second group of scores;
assigning the new score an equal payout rate as a function of whether the new score is categorized in the first group of scores or the second group of scores;
deriving a new payout rate for the new score; and
transmitting an electronic communication comprising the new rate to a payout virtual reel.

20. A computer-implemented method for altering payout rates, the method comprising:
a payout adjuster that derives payout opportunities for groups of players of a game as a function of player ranks and payout virtual reels;
a pseudo-random number generator that generates a random number; and
a virtual reel having discrete payout rate ranges, wherein the virtual reel selects at least one of the payout rate ranges as a function of the generated random number and the derived payout opportunities for the groups of players.
